(19) United States
(12) Patent Application Publication
(10) Pub. No.: US 2002/0109065 A1
(43) Pub. Date: Aug. 15, 2002

(54) Pole-type member support device and method therefor

(76) Inventor: Edgardo Clores, Las Vegas, NV (US)

Correspondence Address: WEISS & MOY PC, 4204 NORTH BROWN AVENUE, SCOTTSDALE, AZ, 85251, US

(21) Appl. No.: 09/779,408

(22) Filed: Feb. 9, 2001

(51) Int. Cl. F16M 13/00

(52) U.S. Cl. 248/519; 248/523

(57) ABSTRACT

A pole-type member support device and method therefor, comprising a base member, two adjustable vertical support members, and a plurality of substantially C-shaped arms coupled thereto and adapted to securely receive a portion of a tree or other pole-type member.

### FIELD OF THE INVENTION

This invention relates generally to poles, trees and other elongated objects and, more specifically, to a pole member support device and method therefor for securely supporting poles, trees and other elongated objects.

### BACKGROUND OF THE INVENTION

During the holiday season, many people bring Christmas trees into their homes for both decorative and religious purposes. The Christmas trees often vary in height and size, creating varying degrees of difficulty in supporting the trees in a stable position. Other people purchase or rent trees, tiki torches or other pole-type items for special events and occasions. In these cases as well it is difficult to support these items in a stable manner. Often, the result is that the trees, poles or other items are either leaned against a wall or propped up in some other unstable way. This lack of a proper support device can lead to a number of unwanted consequences ranging from a mess to severe physical injury. A tree falling from an unstable position can cause not only property damage but can also bring severe harm to a person. Likewise, a falling tiki torch or a pole-type item with a candle or other lit object on top could ignite a fire.

Previous attempts have been made to provide a support device for Christmas trees. For example, U.S. Pat. No. 5,970,655 issued to Freeman discloses a Christmas tree resting inside a collar member having a radial extension and a rod coupled between the tree and the radial extension. The Freeman patent requires the attachment of a rod to a portion of the tree, a time-consuming and difficult process. Additionally, the Freeman patent does not provide a collar capable of being adjusted to the varying thickness of different trees or other pole-type members.

A need therefore existed for a pole member support device capable of being adjusted to securely support a tree or other pole-type member of varying degrees of thickness.

### SUMMARY OF THE INVENTION

An object of the present invention is to provide a device and method capable of receiving and securely supporting a tree or pole-type member of varying degrees of thickness.

It is a further object of the present invention to provide a device and method capable of receiving and securely supporting a tree in a water-filled receptacle.

### BRIEF DESCRIPTION OF THE PREFERRED EMBODIMENTS

In accordance with one embodiment of the present invention, a pole-type member support device is disclosed, comprising, in combination, a substantially hollow base member having a first side and a second side and a first end and a second end and a top surface and a bottom surface, the top surface of the base member defines a first slotted opening between a center portion of the top surface and the first end of the base member and the top surface of the base member defines a second slotted opening between the center portion of the top surface and the second end of the base member, a first vertical support member having a base portion and a top portion and a spine therebetween, the base portion is dimensioned to reside in the hollow base member and the spine is dimensioned to extend through the first slotted opening, a second vertical support member having a base portion and a top portion and a spine therebetween, the base portion of the second vertical support member is dimensioned to reside in the hollow base member and the spine of the second vertical support member is dimensioned to extend through the second slotted opening, a first plurality of substantially C-shaped arms coupled to the first vertical support member at spaced-apart intervals, and a second plurality of substantially C-shaped arms coupled to the second vertical support member at spaced-apart intervals so as to communicate with the first plurality of substantially C-shaped arms to form a substantially round-shaped cavity between the spine of the first vertical support member and the spine of the second vertical support member through which a portion of the pole member could be inserted.

In accordance with another embodiment of the present invention, a tree support device is disclosed, comprising, in combination, a substantially hollow base member having a first side and a second side and a first end and a second end and a top surface and a bottom surface, the top surface of the base member defines a receptacle dimensioned to receive water and a bottom portion of a tree, the top surface of the base member defines a first slotted opening between the first end of the base member and the receptacle and the top surface of the base member defines a second slotted opening between the receptacle and the second end of the base member, a first vertical support member having a base portion and a top portion and a spine therebetween, the base portion is dimensioned to reside in the hollow base member and the spine is dimensioned to extend through the first slotted opening, a second vertical support member having a base portion and a top portion and a spine therebetween, the base portion of the second vertical support member is dimensioned to reside in the hollow base member and the spine of the second vertical support member is dimensioned to extend through the second slotted opening, a first plurality of substantially C-shaped arms coupled to the first vertical support member at spaced-apart intervals, and a second plurality of substantially C-shaped arms coupled to the second vertical support member at spaced-apart intervals so as to communicate with the first plurality of substantially C-shaped arms to form a substantially round-shaped cavity between the spine of the first vertical support member and the spine of the second vertical support member through which said bottom portion of said tree could be inserted.

In accordance with still another embodiment of the present invention, a method for supporting a tree in a water-filled receptacle is disclosed, comprising, in combination, the steps of providing a substantially hollow base member having a first side and a second side and a first end and a second end and a top surface and a bottom surface, the top surface of the base member defines a receptacle dimensioned to receive water and a bottom portion of a tree, the top surface of the base member defines a first slotted opening between the first end of the base member and the receptacle and the top surface of the base member defines a second slotted opening between the receptacle and the second end of the base member, providing a first vertical support member having a base portion and a top portion and a spine therebetween, the base portion is dimensioned to reside in the hollow base member and the spine is dimensioned to extend through the first slotted opening, providing a second vertical support member having a base portion and a top portion and a spine therebetween, the base portion of the second vertical support member is dimensioned to reside in the hollow base member and the spine of the second vertical support member is dimensioned to extend through the second slotted opening, providing a first plurality of substantially C-shaped arms coupled to the first vertical support member at spaced-apart intervals, providing a second plurality of substantially C-shaped arms coupled to the second vertical support member at spaced-apart intervals so as to communicate with the first plurality of substantially C-shaped arms to form a substantially round-shaped cavity between the spine of the first vertical support member and the spine of the second vertical support member through which said bottom portion of the tree could be inserted, filling the receptacle with water, longitudinally adjusting the first vertical support member and the second vertical support member to create the substantially round-shaped cavity between the spine of the first vertical support member and the spine of the second vertical support member, and inserting the bottom portion of the tree into the round-shaped cavity between the spine of the first vertical support member and the spine of the second vertical support member.

The foregoing and other objects, features, and advantages of the invention will be apparent from the following, more particular description of the preferred embodiments of the invention, as illustrated in the accompanying drawings.

### BRIEF DESCRIPTION OF THE DRAWINGS

FIG. 1 is a perspective view of one embodiment of the pole-type member support device of the present invention.

FIG. 2 is a breakaway view of the pole-type member support device of FIG. 1, showing the upper portion in an elevational view and the lower portion in a side view.

FIG. 3 is a perspective view of the base portion of the first vertical support member of the pole-type member support device of FIG. 1.

FIG. 3a is a perspective view of the base portion of the second vertical support member of the pole-type member support device of FIG. 1.

FIG. 4 is a perspective view of an alternative embodiment of the pole-type member support device of the present invention, showing the water-filled receptacle.

FIG. 5 is a breakaway view of the pole-type member support device of FIG. 4, showing the upper portion in an elevational view and the lower portion in a side view.

FIG. 6 is a perspective view of the base portion of the first vertical support member of the pole-type member support device of FIG. 4.

FIG. 6a is a perspective view of the base portion of the second vertical support member of the pole-type member support device of FIG. 4.

### DETAILED DESCRIPTION OF THE PREFERRED EMBODIMENTS

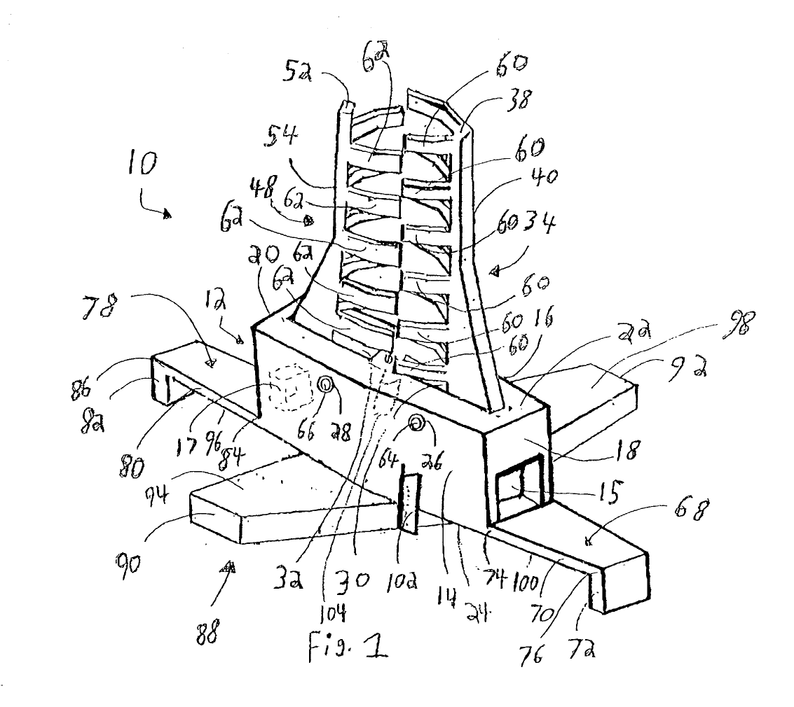

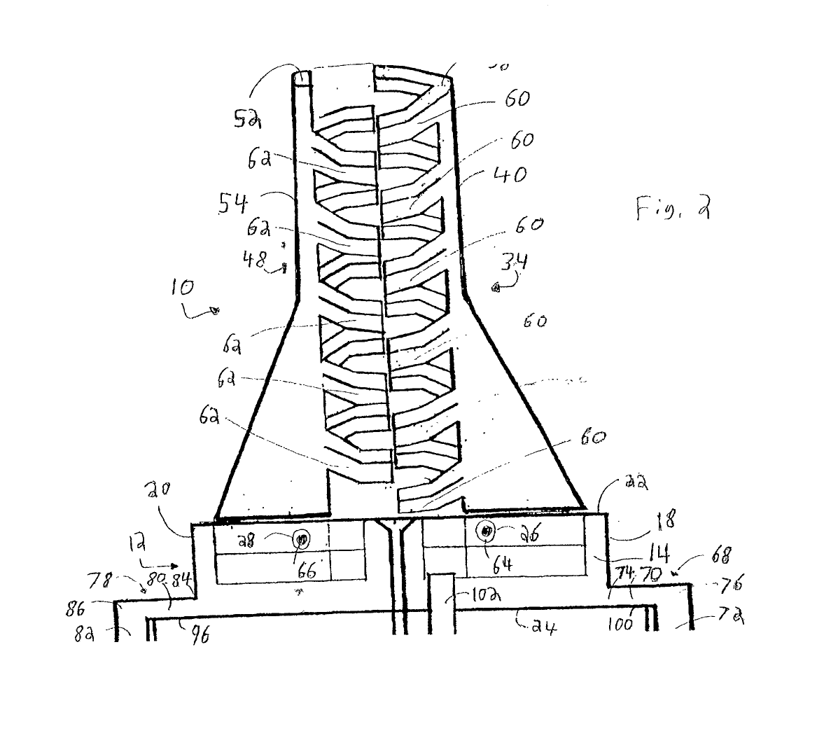

Referring to FIGS. 1 and 2 reference number 10 refers generally to the pole-type member support device of the present invention. The pole-type member support device 10 generally comprises a substantially hollow base member 12 having a first side 14, a second side 16 (shown in FIG. 1), a first end 18, a second end 20, a top surface 22 and a bottom surface 24. The top surface 22 of the base member 12 defines a first slotted opening 30 (shown in FIG. 1) between a center portion of the top surface 22 and the first end 18 of the base member 12. The top surface 22 of the base member 12 also defines a second slotted opening 32 (shown in FIG. 1) between a center portion of the top surface 22 and the second end 20 of the base member 12. Preferably, the first end 18 of the base member 12 defines a first cavity 15 (shown in FIG. 1) and the second end 20 of the base member 12 defines a second cavity 17 (shown in phantom in FIG. 1). The first cavity 15 and the second cavity 17 are preferably adapted to be used as a gripping mechanism to lift the base member 12 in order to move the pole-type member support device 10 to a desired location. While, in the preferred embodiment, the base member 12 includes a first cavity 15 and a second cavity 17 it should be clearly understood that substantial benefit could be derived from an alternative configuration of the pole-type member support device 10 which lacks these cavities.

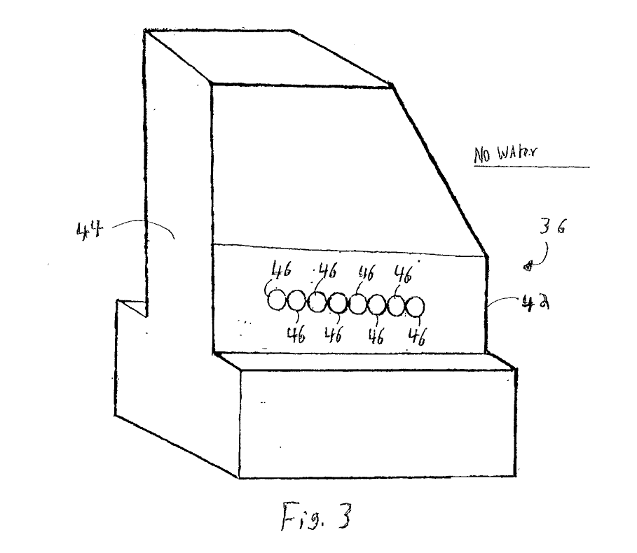

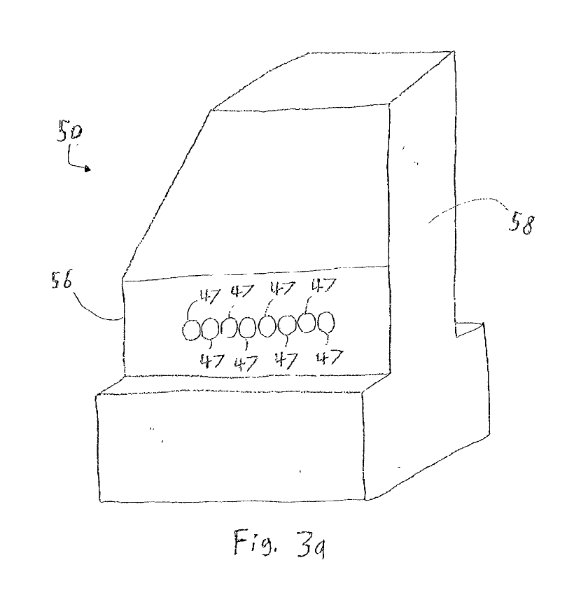

Referring now to FIGS. 1-3, the pole-type member support device 10 further comprises a first vertical support member 34 (shown in FIGS. 1-2). The first vertical support member 34 has a base portion 36 (shown in FIG. 3), a top portion 38 (shown in FIGS. 1-2), and a spine 40 (shown in FIGS. 1-2) therebetween. The base portion 36 is dimensioned to reside in the substantially hollow base member 12 with the spine 40 dimensioned to extend through the first slotted opening 30.

Referring now to FIGS. 1, 2 and 3a, the pole-type member support device 10 further comprises a second vertical support member 48 (shown in FIGS. 1-2) of substantially the same configuration of the first vertical support member 34. The second vertical support member 48 has a base portion 50 (shown in FIG. 3a), a top portion 52 (shown in FIGS. 1-2), and a spine 54 (shown in FIGS. 1-2) therebetween. The base portion 50 is dimensioned to reside in the base member 12 with the spine 54 dimensioned to extend through the second slotted opening 32.

Referring now to FIGS. 1 and 2, the pole-type member support device 10 further comprises a first plurality of substantially C-shaped arms 60 coupled to the first vertical support member 34 at spaced-apart intervals. A second plurality of substantially C-shaped arms 62 are coupled to the second vertical support member 48 at spaced-apart intervals. The first plurality of substantially C-shaped arms 60 and the second plurality of substantially C-shaped arms 62 are dimensioned to communicate with each other to form a substantially round-shaped cavity between the spine 40 of the first vertical support member 34 and the spine 54 of the second vertical support member 48 through which a portion of a pole member (not shown), such as a tree, tiki torch, or other elongated pole-type member, could be inserted.

In the preferred embodiment, the first vertical support member 34 is adapted to move longitudinally between the first end 18 of the base member and a center portion of the base member 12. Preferably, the second vertical support member 48 is adapted to move longitudinally between the second end 20 of the base member 12 and a center portion of the base member 12. In this way, the two vertical support members can be longitudinally adjusted to allow pole members of varying thickness to be securely inserted between the vertical support members. In the preferred embodiment, the first side 14 of the base member 12 defines a first aperture 26 between the first end 18 and a center portion of the first side 14. Preferably, the first side 14 defines a second aperture 28 between the second end 20 and a center portion of the first side 14. Preferably, the base portion 36 (shown in FIG. 3) of the first vertical support member 34 has a first end 42 and a second end 44 and defines a plurality of apertures 46 (shown in FIG. 3) disposed longitudinally therebetween at a height substantially equivalent to a height of the first aperture 26 of the base member 12. Preferably, the base portion 50 (shown in FIG. 3a) of the second vertical support member 48 has a first end 56 and a second end 58 and defines a plurality of apertures 47 (shown in FIG. 3a) disposed longitudinally therebetween at a height substantially equivalent to a height of the second aperture 28 of the base member 12. In the preferred embodiment, the pole-type member support device 10 further comprises a first pin 64 (shown in FIGS. 1-2) dimensioned to extend through the first aperture 26 of the base member 12 and one of the plurality of apertures 46 of the base portion 36 of the first vertical support member 34. Preferably, the pole-type member support device 10 also comprises a second pin 66 (shown in FIGS. 1-2) dimensioned to extend through the second aperture 28 of the base member 12 and one of the plurality of apertures 47 of the base portion 50 of the second vertical support member 48. When inserted, the first pin 64 and the second pin 66 lock the first vertical support member 34 and the second vertical support member 48, respectively, into position relative the base member 12. When the first pin 64 and the second pin 66 are removed, the first vertical support member 34 and the second vertical support member 48 may be adjusted longitudinally to accommodate pole-type members of varying degrees of thickness. Preferably, the first pin 64 and the second pin 66 are spring-biased although substantial benefit could be derived from a first pin 64 and a second pin 66 which are not spring-biased. While, in the preferred embodiment, the vertical support members can be longitudinally adjusted, the base member 12 defines apertures which correspond to apertures in the base portions of the vertical support members, and pins are used to lock the vertical support members into position relative to the base member it should be clearly understood that substantial benefit could be derived from an alternative configuration of the pole-type member support device 10 in which the vertical support members are fixed and no apertures or pins are used to lock the vertical support members into position relative the base member 12.

Referring now to FIGS. 1-2, in the preferred embodiment the bottom surface 24 of the base member 12 further comprises a first substantially L-shaped leg 68 having an elongated horizontal portion 70 and a vertical portion 72. The horizontal portion 70 has a first end 74 and a second end 76. The first end 74 is coupled to the first end 18 of the base member 12 and extends longitudinally away from the base member 12. The second end 76 is coupled to the vertical portion 72. The bottom surface 24 of the base member 12 also preferably comprises a second substantially L-shaped leg 78 having an elongated horizontal portion 80 and a vertical portion 82. The horizontal portion 80 has a first end 84 and a second end 86. The first end 84 is coupled to the second end 20 of the base member 12 and extends longitudinally away from the base member 12. The second end 86 is coupled to the vertical portion 82.

Referring now to FIG. 1, the bottom surface 24 of the base member 12 preferably further comprises a stabilizing brace 88 having a first end 90 and a second end 92. The stabilizing brace 88 is rotatably coupled to the bottom surface 24 of the base member 12. The stabilizing brace 88 has a thickness less than the length of the vertical portions 72 and 82 of the first and second substantially L-shaped legs 68 and 78, respectively. The stabilizing brace 88 is dimensioned to be rotated to an open position wherein the first end 90 of the stabilizing brace 88 is at a substantially ninety degree angle to both the first substantially L-shaped leg 68 and the second substantially L-shaped leg 78. In the open position, the second end 92 of the stabilizing brace 88 is also at a substantially ninety degree angle to both the first substantially L-shaped leg 68 and the second substantially L-shaped leg 78 In the open position, the stabilizing brace 88 provides the pole-type member support device 10 with greater stability in supporting a pole, tree or other pole-type member. The stabilizing brace 88 is also preferably dimensioned to be rotated to a closed position wherein a top surface 94 of the first end 90 of the stabilizing brace 88 is proximate a bottom surface 96 of the horizontal portion 80 of the second substantially L-shaped leg 78, and a top surface 98 of the second end 92 of the stabilizing brace 88 is proximate a bottom surface 100 of the horizontal portion 70 of the first substantially L-shaped leg 68. While, in the preferred embodiment, the pole-type member support device 10 comprises a stabilizing brace 88, it should be clearly understood that substantial benefit could be derived from an alternative configuration of the pole-type member support device 10 which lacks a stabilizing brace 88.

In the preferred embodiment, the base member 12 further comprises a first retractable stop member 102 (shown in FIGS. 1-2) coupled to the first side 14 of the base member 12 between a center portion of the base member 12 and the first end 18 of the base member 12. The first retractable stop member 102 is dimensioned to be lowered so as to prevent the first end 90 of the stabilizing brace 88 from rotating towards the first substantially L-shaped leg 68. The first retractable stop member 102 is also dimensioned to be raised to allow free rotation of the stabilizing brace 88. Preferably, a second retractable stop member 104 (shown in phantom in FIG. 1) is coupled to the second side 16 of the base member 12 between a center portion of the base member 12 and the second end 20 of the base member 12. The second retractable stop member 104 is dimensioned to be lowered so as to prevent the second end 92 of the stabilizing brace 88 from rotating towards the second substantially L-shaped leg 78. The second retractable stop member 104 is also dimensioned to be raised to allow free rotation of the stabilizing brace 88. While, in the preferred embodiment, the base member 12 comprises a first retractable stop member 102 and a second retractable stop member 104 it should be clearly understood that substantial benefit could be derived from an alternative configuration of the pole-type member support device 10 which lacks retractable stop members altogether or provides for an alternative mechanism for the prevention of free rotation of the support brace 88, such as an insertable pin or a high coefficient of friction.

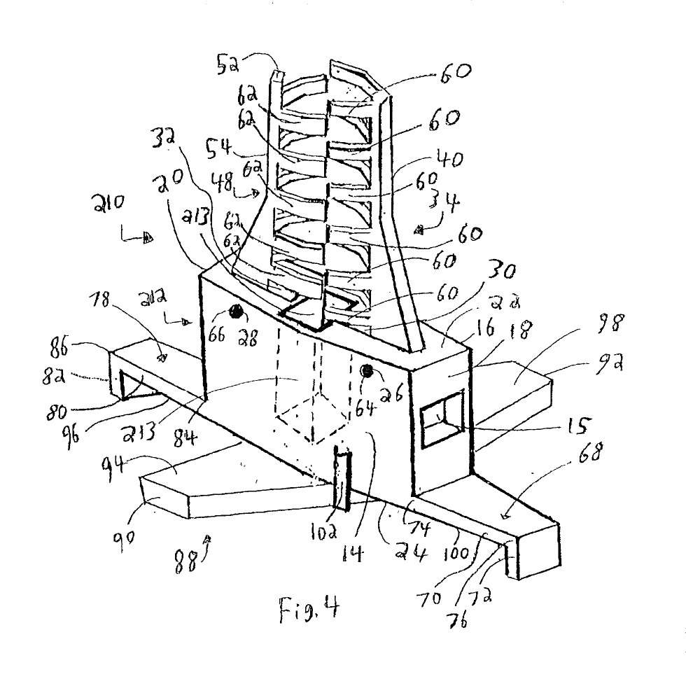

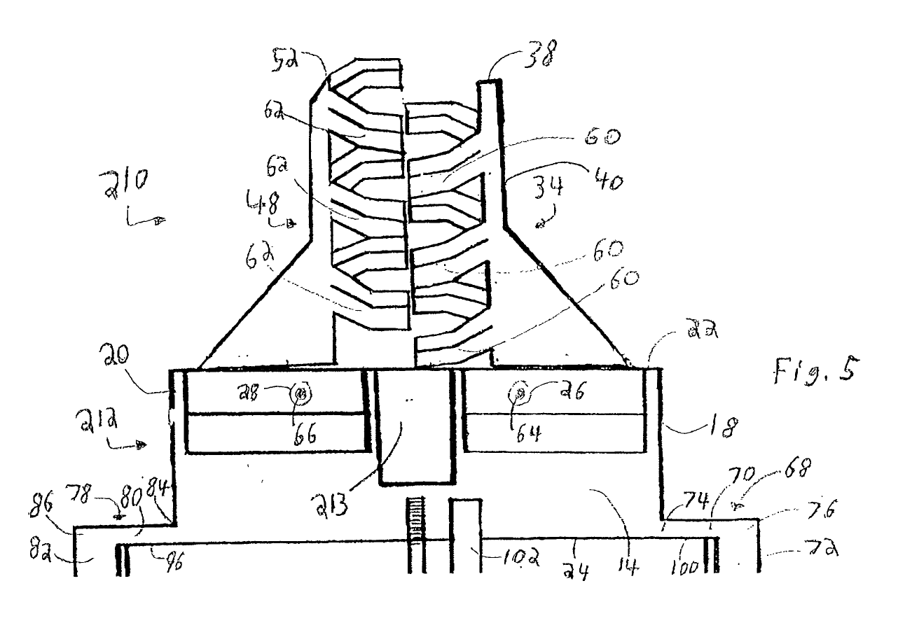

Referring now to FIGS. 4-6a, an alternative embodiment of the pole-type member support device 10, hereinafter 210, is disclosed. The pole-type member support device 210 is essentially the same as before, although the top surface 22 of the base portion 212 defines a receptacle 213 dimensioned to receive water (not shown) and a bottom portion of a tree (not shown). For this reason, the same reference numbers used in describing the features of the pole-type member support device 10 of the preferred embodiment will be used when describing the identical features of the pole-type member support device 210. In order to accommodate the receptacle 213, the distance between the top surface 22 and the bottom surface 24 of the base member 212 is greater than the distance between the top surface 22 and the bottom surface 24 of the base member 12 of the preferred embodiment.

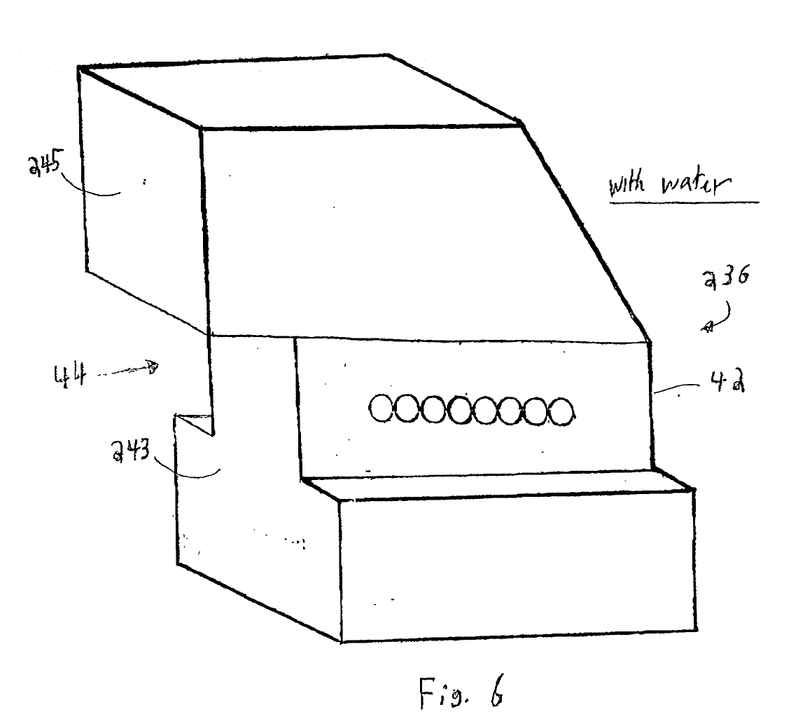

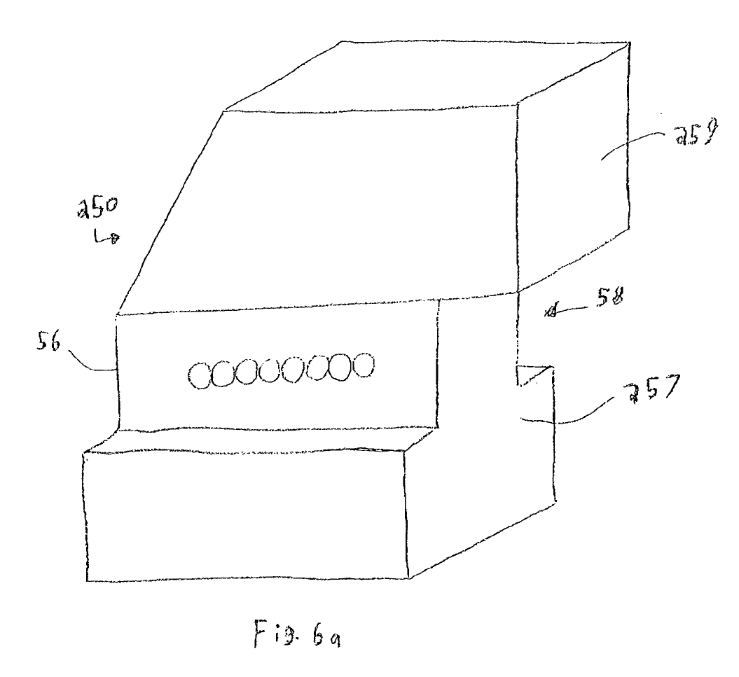

Referring now to FIGS. 6-6a, the second side 44 of the base portion 236 (shown in FIG. 6) of the first vertical support member 34 of the pole-type member support device 210 defines an upper portion 245 and a lower portion 243, wherein the longitudinal distance between the first end 42 and the upper portion 245 is greater than the longitudinal distance between the first end 42 and the lower portion 243 in order to accommodate the receptacle 213. Similarly, the second side 58 of the base portion 250 (shown in FIG. 6a) of the second vertical support member 48 of the pole-type member support device 210 defines an upper portion 259 and a lower portion 257, wherein the longitudinal distance between the first end 56 and the upper portion 259 is greater than the longitudinal distance between the first end 56 and the lower portion 257 in order to accommodate the receptacle 213. In all other ways, the pole-type member support device 210 functions in the same way as the pole-type member support device 10.

While the invention has been particularly shown and described with reference to preferred embodiments thereof, it will be understood by those skilled in the art that the foregoing and other changes in form and details may be made therein without departing from the spirit and scope of the invention.

I claim:

1. A pole-type member support device comprising, in combination:
a substantially hollow base member having a first side and a second side and a first end and a second end and a top surface and a bottom surface, said top surface of said base member defines a first slotted opening between a center portion of said top surface and said first end of said base member and said top surface of said base member defines a second slotted opening between said center portion of said top surface and said second end of said base member;
a first vertical support member having a base portion and a top portion and a spine therebetween, said base portion is dimensioned to reside in said hollow base member and said spine is dimensioned to extend through said first slotted opening;
a second vertical support member having a base portion and a top portion and a spine therebetween, said base portion of said second vertical support member is dimensioned to reside in said hollow base member and said spine of said second vertical support member is dimensioned to extend through said second slotted opening;
a first plurality of substantially C-shaped arms coupled to said first vertical support member at spaced-apart intervals; and
a second plurality of substantially C-shaped arms coupled to said second vertical support member at spaced-apart intervals so as to communicate with said first plurality of substantially C-shaped arms to form a substantially round-shaped cavity between said spine of said first vertical support member and said spine of said second vertical support member through which a portion of said pole member could be inserted.

2. The device of claim 1 wherein said base portion of said first vertical support member has a first end and a second end and defines a plurality of apertures disposed longitudinally therebetween and said base portion of said second vertical support member has a first end and a second end and defines a plurality of apertures disposed longitudinally therebetween.

3. The device of claim 2 further comprising:
a first pin dimensioned to extend through a first aperture of said base member and one of said plurality of apertures of said base portion of said first vertical support member to lock said first vertical support member in position relative to said base member; and
a second pin dimensioned to extend through a second aperture of said base member and one of said plurality of apertures of said base portion of said second vertical support member to lock said second vertical support member in position relative to said base member.

4. The device of claim 3 wherein said first pin and said second pin are spring-biased.

5. The device of claim 1 wherein said bottom surface of said base member further comprises:
a first substantially L-shaped leg having an elongated horizontal portion and a vertical portion, said horizontal portion has a first end coupled to said first end of said base member and extending longitudinally away from said base member and a second end coupled to said vertical portion;
a second substantially L-shaped leg having an elongated horizontal portion and a vertical portion, said horizontal portion has a first end coupled to said second end of said base member and extending longitudinally away from said base member and a second end coupled to said vertical portion; and
a stabilizing brace having a first end and a second end and rotatably coupled to said bottom surface of said base member and having a thickness less than a length of said vertical portion of said first and said second substantially L-shaped legs, said stabilizing brace is dimensioned to be rotated to an open position wherein said first end of said stabilizing brace is at a substantially ninety degree angle to both said first substantially L-shaped leg and said second substantially L-shaped leg and said second end of said stabilizing brace is at a substantially ninety degree angle to both said first substantially L-shaped leg and said second substantially L-shaped leg, said stabilizing brace is dimensioned to be rotated to a closed position wherein a top surface of said first end of said stabilizing brace is proximate a bottom surface of said horizontal portion of said second substantially L-shaped leg and a top surface of said second end of said stabilizing brace is proximate a bottom surface of said horizontal portion of said first substantially L-shaped leg.

6. The device of claim 5 further comprising:
a first retractable stop member coupled to said first side of said base member between a center portion of said base member and said first end of said base member and dimensioned to be lowered so as to prevent said first end of said stabilizing brace from rotating towards said first substantially L-shaped leg and said first retractable stop member is dimensioned to be raised to allow free rotation of said stabilizing brace; and
a second retractable stop member coupled to said second side of said base member between a center portion of said base member and said second end of said base member and dimensioned to be lowered so as to prevent said second end of said stabilizing brace from rotating towards said second substantially L-shaped leg and said second retractable stop member is dimensioned to be raised to allow free rotation of said stabilizing brace.

7. The device of claim 1 wherein said first end of said base member defines a first cavity and said second end of said base member defines a second cavity, said first cavity and said second cavity are adapted to be used as a gripping mechanism to lift said base member.

8. The device of claim 1 wherein said first vertical support member is adapted to move longitudinally between said first end of said base member and a center portion of said base member and said second vertical support member is adapted to move longitudinally between said second end of said base member and a center portion of said base member.

9. A tree support device comprising, in combination:
a substantially hollow base member having a first side and a second side and a first end and a second end and a top surface and a bottom surface, said top surface of said base member defines a receptacle dimensioned to receive water and a bottom portion of a tree, said top surface of said base member defines a first slotted opening between said first end of said base member and said receptacle and said top surface of said base member defines a second slotted opening between said receptacle and said second end of said base member;
a first vertical support member having a base portion and a top portion and a spine therebetween, said base portion is dimensioned to reside in said hollow base member and said spine is dimensioned to extend through said first slotted opening;
a second vertical support member having a base portion and a top portion and a spine therebetween, said base portion of said second vertical support member is dimensioned to reside in said hollow base member and said spine of said second vertical support member is dimensioned to extend through said second slotted opening;
a first plurality of substantially C-shaped arms coupled to said first vertical support member at spaced-apart intervals; and
a second plurality of substantially C-shaped arms coupled to said second vertical support member at spaced-apart intervals so as to communicate with said first plurality of substantially C-shaped arms to form a substantially round-shaped cavity between said spine of said first vertical support member and said spine of said second vertical support member through which said bottom portion of said tree could be inserted.

10. The device of claim 9 wherein said base portion of said first vertical support member has a first end and a second end and defines a plurality of apertures disposed longitudinally therebetween and said base portion of said second vertical support member has a first end and a second end and defines a plurality of apertures disposed longitudinally therebetween.

11. The device of claim 10 further comprising:
a first pin dimensioned to extend through a first aperture of said base member and one of said plurality of apertures of said base portion of said first vertical support member to lock said first vertical support member in position relative to said base member; and
a second pin dimensioned to extend through a second aperture of said base member and one of said plurality of apertures of said base portion of said second vertical support member to lock said second vertical support member in position relative to said base member.

12. The device of claim 11 wherein said first pin and said second pin are spring-biased.

13. The device of claim 9 wherein said bottom surface of said base member further comprises:
a first substantially L-shaped leg having an elongated horizontal portion and a vertical portion, said horizontal portion has a first end coupled to said first end of said base member and extending longitudinally away from said base member and a second end coupled to said vertical portion;
a second substantially L-shaped leg having an elongated horizontal portion and a vertical portion, said horizontal portion has a first end coupled to said second end of said base member and extending longitudinally away from said base member and a second end coupled to said vertical portion; and
a stabilizing brace having a first end and a second end and rotatably coupled to said bottom surface of said base member and having a thickness less than a length of said vertical portion of said first and said second substantially L-shaped legs, said stabilizing brace is dimensioned to be rotated to an open position wherein said first end of said stabilizing brace is at a substantially ninety degree angle to both said first substantially L-shaped leg and said second substantially L-shaped leg and said second end of said stabilizing brace is at a substantially ninety degree angle to both said first substantially L-shaped leg and said second substantially L-shaped leg, said stabilizing brace is dimensioned to be rotated to a closed position wherein a top surface of said first end of said stabilizing brace is proximate a bottom surface of said horizontal portion of said second substantially L-shaped leg and a top surface of said second end of said stabilizing brace is proximate a bottom surface of said horizontal portion of said first substantially L-shaped leg.

14. The device of claim 13 further comprising:
a first retractable stop member coupled to said first side of said base member between a center portion of said base member and said first end of said base member and dimensioned to be lowered so as to prevent said first end of said stabilizing brace from rotating towards said first substantially L-shaped leg and said first retractable stop member is dimensioned to be raised to allow free rotation of said stabilizing brace; and
a second retractable stop member coupled to said second side of said base member between a center portion of said base member and said second end of said base member and dimensioned to be lowered so as to prevent said second end of said stabilizing brace from rotating towards said second substantially L-shaped leg and said second retractable stop member is dimensioned to be raised to allow free rotation of said stabilizing brace.

15. The device of claim 9 wherein said first end of said base member defines a first cavity and said second end of said base member defines a second cavity, said first cavity and said second cavity are adapted to be used as a gripping mechanism to lift said base member.

16. The device of claim 9 wherein said first vertical support member is adapted to move longitudinally between said first end of said base member and said receptacle, and said second vertical support member is adapted to move longitudinally between said second end of said base member and said receptacle.

17. A method for supporting a tree in a water-filled receptacle comprising, in combination, the steps of:
providing a substantially hollow base member having a first side and a second side and a first end and a second end and a top surface and a bottom surface, said top surface of said base member defines a receptacle dimensioned to receive water and a bottom portion of a tree, said top surface of said base member defines a first slotted opening between said first end of said base member and said receptacle and said top surface of said base member defines a second slotted opening between said receptacle and said second end of said base member;
providing a first vertical support member having a base portion and a top portion and a spine therebetween, said base portion is dimensioned to reside in said hollow base member and said spine is dimensioned to extend through said first slotted opening;
providing a second vertical support member having a base portion and a top portion and a spine therebetween, said base portion of said second vertical support member is dimensioned to reside in said hollow base member and said spine of said second vertical support member is dimensioned to extend through said second slotted opening;
providing a first plurality of substantially C-shaped arms coupled to said first vertical support member at spaced-apart intervals;
providing a second plurality of substantially C-shaped arms coupled to said second vertical support member at spaced-apart intervals so as to communicate with said first plurality of substantially C-shaped arms to form a substantially round-shaped cavity between said spine of said first vertical support member and said spine of said second vertical support member through which said bottom portion of said tree could be inserted;
filling said receptacle with water;
longitudinally adjusting said first vertical support member and said second vertical support member to create said substantially round-shaped cavity between said spine of said first vertical support member and said spine of said second vertical support member; and
inserting said bottom portion of said tree into said round-shaped cavity between said spine of said first vertical support member and said spine of said second vertical support member.
